(19) United States
(12) Patent Application Publication
(10) Pub. No.: US 2026/0154288 A1
(43) Pub. Date: Jun. 4, 2026

(54) VERTICAL AND HORIZONTAL SCALING OF COMPONENTS OF A DISTRIBUTED DATABASE

(71) Applicant: Amazon Technologies, Inc., Seattle, WA (US)

(72) Inventors: Marc Brooker, Seattle, WA (US); Marc Bowes, Seattle, WA (US); Steven Michael Hershey, Seattle, WA (US); Gourav Roy, Issaquah, WA (US); Izak Van Der Merwe, Seattle, WA (US); James Alexander Morle, Dripping Springs, TX (US); Jai Prakash Chabria, Bellevue, WA (US); Gaurav Jain, Sammamish, WA (US)

(73) Assignee: Amazon Technologies, Inc., Seattle, WA (US)

(21) Appl. No.: 18/964,234

(22) Filed: Nov. 29, 2024

(51) Int. Cl. G06F 16/27; G06F 9/50

(52) U.S. Cl. CPC G06F 16/27; G06F 9/5083

(57) ABSTRACT

A database system performs vertical scaling of a storage layer by temporarily increasing a resource allocation of given node and/or shard to allow the node or shard to process a load that exceeds its baseline resource allocation. Additionally, a control plane of the database system performs health checks of the nodes and/or shards of the components of the database system and in response to load conditions exceeding a threshold, performs horizontal scaling of the nodes of the components. The horizontal scaling adds shard replicas or re-shards the nodes to include more shards. The horizontal scaling reduces load on individual nodes and/or shards and alleviates the load conditions that triggered the vertical scaling.

### BACKGROUND

Database systems can be scaled up to support greater amounts of load, such as a greater amount of queries, writes, or data storage being requested to be performed by the database. Such scaling is often performed by partitioning the database into more partitions, with each resulting partition being responsible for a smaller range of keys of the database. However, such horizontal scaling can cause interruptions in service while re-partitioning activities are being performed. Also, database loads can fluctuate over time, such that conditions may repeatedly change, such as between conditions that warrant further partitioning and conditions that warrant combining partitions. In such scenarios, database resources may be inefficiently used when performing partitioning in response to a fluctuating load level.

### BRIEF DESCRIPTION OF THE DRAWINGS

FIGS. 1A-1C are block diagrams illustrating a database service which supports both horizontal scaling of components of a distributed database, such as storage nodes of a storage layer, (e.g. by adding more shards or shard replicas) and vertical scaling of nodes of the components of the distributed database, such as the storage nodes of the storage layer, by increasing a resource allocation quota for a given node of one or more of the components, such as storage nodes of the storage layer storing one or more shards with an elevated resource load, according to some embodiments.

FIGS. 2A-2B are block diagrams illustrating a control plane of a distributed database collecting shard load information and making horizontal scaling decisions based on the collected shard loading information, according to some embodiments.

FIG. 3 illustrates an example graph of resource usage over time indicated in collected shard load information, and further illustrates conditions that resulted in vertical scaling and horizontal scaling of components of the distributed database based on the resource usage observed over time, according to some embodiments.

FIG. 4 illustrates an example of a resource usage trend generated by filtering collected load and/or health information, wherein a control plane of the distributed database performs horizontal scaling evaluations using the resource usage trends resulting from the filtering, according to some embodiments.

FIGS. 5A-5C are block diagrams illustrating the database service performing a vertical scaling operation with regard to disk storage and also performing a horizontal scaling operation to increase disk storage capacity for a distributed database, according to some embodiments.

FIG. 6 is a block diagram illustrating example horizontal scaling operations that can be performed to increase a capacity of components of a distributed database, according to some embodiments.

FIG. 7 is a flowchart illustrating processes followed by components of a distributed database to perform vertical and horizontal scaling, according to some embodiments.

FIG. 8 is a flowchart for a process for a control plane of a distributed database system to collect health information from components of a distributed database system and use the health information to make horizontal scaling decisions for the components, according to some embodiments.

FIG. 9 is a flowchart for a process performed by a control plane to monitor query processor usage and scale query processor capacity, according to some embodiments.

FIG. 10 is a block diagram illustrating a query processor to storage network wherein query processors share connections to storage nodes, according to some embodiments.

FIG. 11 is a block diagram illustrating a database service which uses a transaction execution manager and processor allocators for distributing client connections and database transactions, according to some embodiments.

FIG. 12 is a block diagram illustrating various components of a database service and storage service that host a distributed database, according to some embodiments.

FIG. 13 is a block diagram illustrating a provider network that may implement database services that implement techniques described herein, according to some embodiments.

FIG. 14 is a block diagram illustrating an example computer system that implements some, or all, of the techniques described herein, according to some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as described by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

### DETAILED DESCRIPTION

A distributed database system provides vertical and horizontal scaling of components of the distributed database. For example, components of a distributed database may perform various functions for the distributed database and may be implemented using a plurality of nodes of that respective component. For example, a storage layer of a distributed database may be implemented using a plurality of storage nodes, and each storage node may be responsible for storing and reading data for multiple shards of the distributed database. In some embodiments, respective ones of the nodes may be implemented using a containerized execution environment, e.g. each node may be configured as an executable container that executes tasks for a given component of the distributed database to which the node belongs. Also, the execution environments in which the nodes are implemented may include other configurations, such as virtual machines or even bare metal hardware. These execution environments, e.g. containers, virtual machines (VMs) etc. are implemented on physical host computing devices with a fixed pool of resources that are shared by the database components implemented on the respective pieces of physical hardware. In some embodiments, in response to an immediate increase in load, the nodes of the database components are vertically scaled, wherein a quota of available host computing device resources allocated for use by a given node being vertically scaled is increased (e.g. quota limitations are relaxed) allowing the given node to exceed its normal-state resource quota allocation for a limited amount of time while being vertically scaled. The decision to allow a vertical scaling to be enabled is performed locally at the host computing device hosting the node being vertically scaled. This allows for fast reaction times between when a vertical scaling condition is encountered and when resource quotas are increased in order to enable the vertical scaling.

Also, a control plane of the distributed database system collects health (e.g. load) information from the nodes of the components of the distributed database and uses the collected health information to determine whether a horizontal scaling of a given component of the distributed database is to be performed. Whereas a vertical scaling event increases a resource allocation of an existing node of a component of the distributed database system, a horizontal scaling increases a number of nodes assigned to a given component being horizontally scaled. For example, horizontally scaling a storage layer of a distributed database may include increasing a number of shards used to store data for the distributed database. This may be performed by re-sharding the storage layer (e.g., a component of the distributed database system) such that more shards are used and such that respective ones of the shards store data for different sets of keys. As another example, horizontal scaling of the storage layer of the distributed database may include adding replicas of existing shards (e.g. that store a same set of keys as existing shards). Replicas may be used to perform reads in parallel with existing shards, thus providing additional capacity. Also, in order to accommodate additional shards (or shard replicas) additional storage nodes may be allocated to the storage layer. Additionally, adding additional storage nodes may cause more physical host computing devices to be used to implement the storage layer and/or cause a greater share of existing host computing device resources to be allocated to the storage layer.

In some embodiments, an increase in capacity of a given component due to a horizontal scaling may alleviate the need for vertical scaling. Thus, subsequent to performing a horizontal scaling, nodes of components of the distributed database that were previously vertical scaled may be returned to their normal-state resource quota limitations (as opposed to the relaxed quotas made available during the vertical scaling).

Said another way, a data plane of a distributed database may allow individual nodes to be vertically scaled without having to interact with a control plane of the distributed database, whereas the control plane is responsible for performing horizontal scaling, The vertical scaling may allow the distributed database to respond to rapid changes in database workload. Also, the horizontal scaling may react to overall resource usage trends and, if a trend continues, cause additional horizontal capacity to be added, which in turns reduces the need for current state vertical scaling and thus provides the ability to vertically scale in the future.

In some embodiments, the vertical scaling may increase a processor resource allocation, a memory resource allocation, and/or a network resource allocation of a given node being vertically scaled. Additionally, in some embodiments, vertical scaling may increase a storage allocation, such as disk space, available for use by a given node.

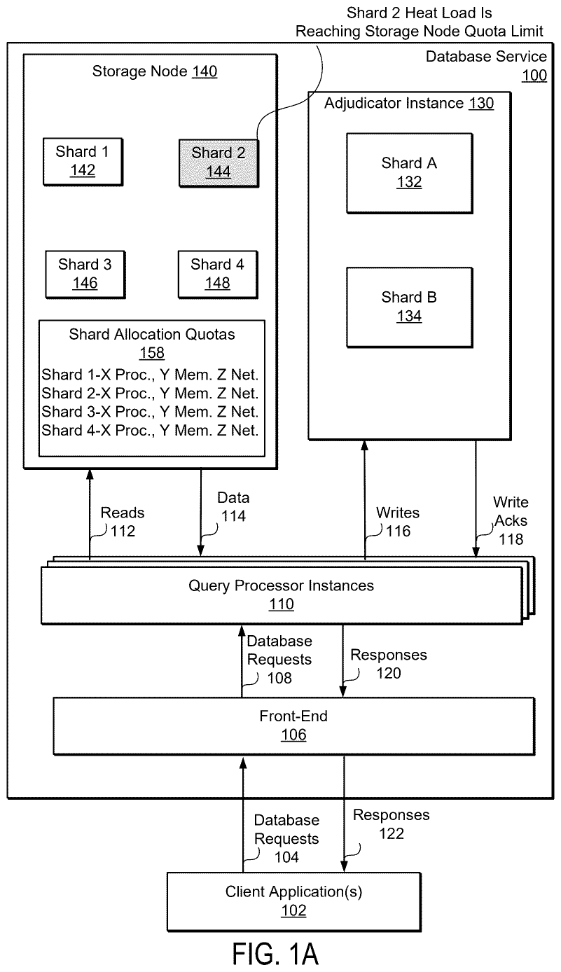

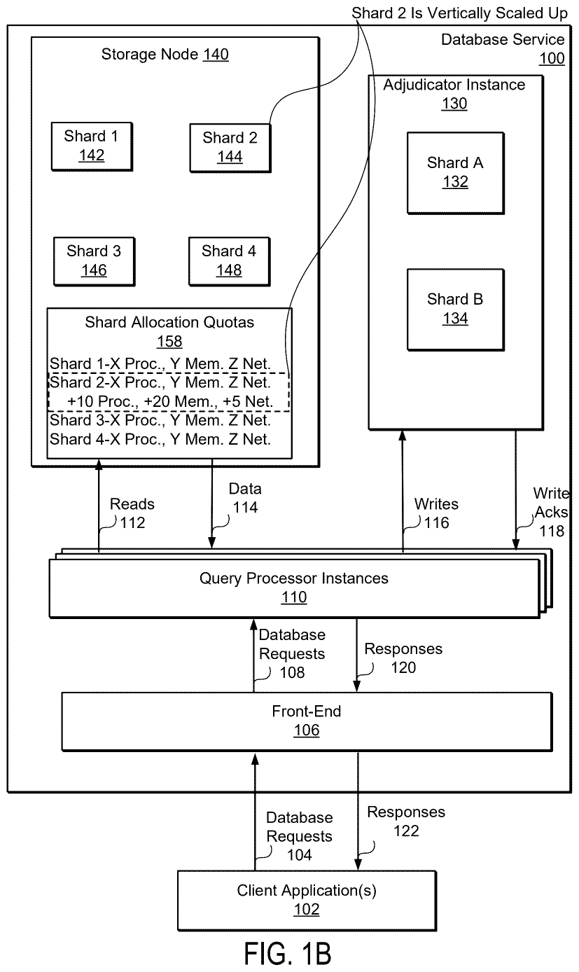

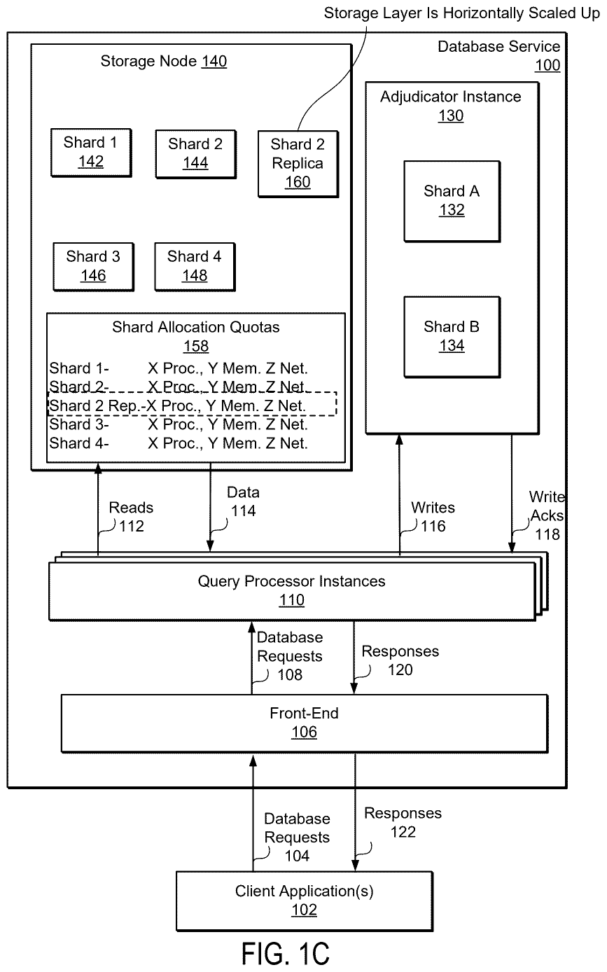

FIGS. 1A-1C are block diagrams illustrating a database service which supports both horizontal scaling of components of a distributed database, such as storage nodes of a storage layer, (e.g. by adding more shards or shard replicas) and vertical scaling of nodes of the components of the distributed database, such as the storage nodes of the storage layer, by increasing a resource allocation quota for a given node of one or more of the components, such as storage nodes of the storage layer storing one or more shards with an elevated resource load, according to some embodiments.

One or more client application(s) 102 may store data to one or more databases maintained by a database service 100. Client application(s) 102 may submit database requests 104 (e.g., requests that cause reads, such as queries or read-only transactions, or requests that cause writes, such as updates, inserts, deletions, or transactions that include write statements) and receive responses 122 from front-end 106.

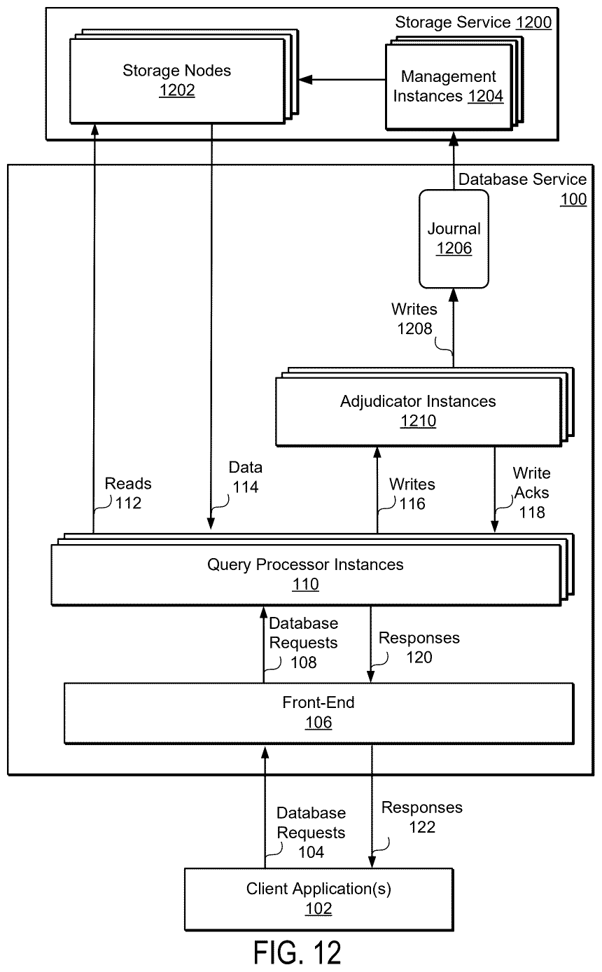

Front-end 106 may dispatch database requests 108 to a query processor instance 110, which may parse the request and interact with different components according to the type of request. For read requests, query processor instance 110 may rely upon a local cache and/or access storage nodes of a storage layer, such as storage node 140, by submitting read requests 112 for data, which are returned as data 114 and used to respond to the read. For writes, write requests 116 may be sent to an adjudicator instance 130, which may determine whether a conflict exists and if not, writes to a journal, such as journal 1206 shown in FIG. 12. The adjudicator instance 130 also acknowledges the write 118 to query processor instance 110. Responses 120 may then be sent to front-end 106 for response 122 to client application(s) 102. Transactions may be applied to the database by management instance, such as management instance 1204 shown in FIG. 12, at a time independent of the write acknowledgement 118, responses 120, and responses 122.

Database service 100 may implement a fleet of host computing devices which may provide, in various embodiments, a multi-tenant configuration so that different query processor instances, such as query processor instance 110 and other query processors, can be hosted on the same virtual machine, but provide access to different databases on behalf of different clients over different connections. In some embodiments, hosts systems may not be multi-tenant and a single virtual machine may implement a single query processor instance 110 which may provide access to a single database for a single client. Similarly host computing devices implementing storage nodes, such as storage node 140, and host computing devices implementing adjudicator instances, such as adjudicator instance 130, may be set up in a multi-tenant configuration.

As can be seen in FIG. 1A shard 2 (144) may have a high heat load. For example, queries processed by query processor instances 110 may be causing a high volume of reads to be performed against keys included in shard 2 (144). In some embodiments, each storage node, such as storage node 140 assigns resource quota limits to each shard serviced by the storage node. For example, shard allocation quotas 158 indicate processor, memory, and network quota limits for each of the shards (e.g. shard 1 (142), shard 2 (144), shard 3 (146), and shard 4 (148)) that are hosted by storage node 140. Likewise a physical host computing device hosting storage node 140 may place processor, memory, and network limitations on how much of these types of resources storage node 140 may consume. However, when vertical scaling is enabled a given shard, such as shard 2 (144) may be allowed to consume more resources than its quota limit. Likewise a storage node, such as storage node 140 may be vertically scaled and allowed to use a greater amount of physical host computing device resources than its normal-state allocation.

In some embodiments, in order to manage vertical scaling, each node of a component of the distributed database system may perform a limited number of tasks and then assess its resource consumption amount against its quota. If the quota is not reached, the node of the component proceeds to perform another limited number of tasks. However, if the quota is reached (or is likely to imminently be reached), the node of the component attempts to enable vertical scaling. For example, for a shard, the storage node 140 may allow a vertical scaling to be enabled thus relaxing the shard allocation quotas 158 for a limited amount of time. As another example, for a storage node, a host computing device may relax quota limitations on resource usage by the given storage node, provided the host computing device hosting the given storage node has excess capacity that is not currently being used.

For example, in FIG. 1B shard 2 (144) is vertically scaled up. As can be seen in shard allocation quotas 158 additional resources are made available to shard 2 (144) as a result of the vertical scaling.

As another example, in FIG. 1C the storage layer (e.g. component) of the distributed database is horizontally scaled. In the example shown in FIG. 1C, this results in a replica shard 160 being added, wherein the replica shard is a replica of shard 2. Also, as can be seen in shard allocation quotas 158, the vertical scaling of shard 2 (144) is ended and instead shard 2 replica (162) now has its own resource quota, e.g. X processor, Y memory, and Z network, that is in addition to the already existing resource quota of shard 2 (144) of X processor, Y memory, and Z network.

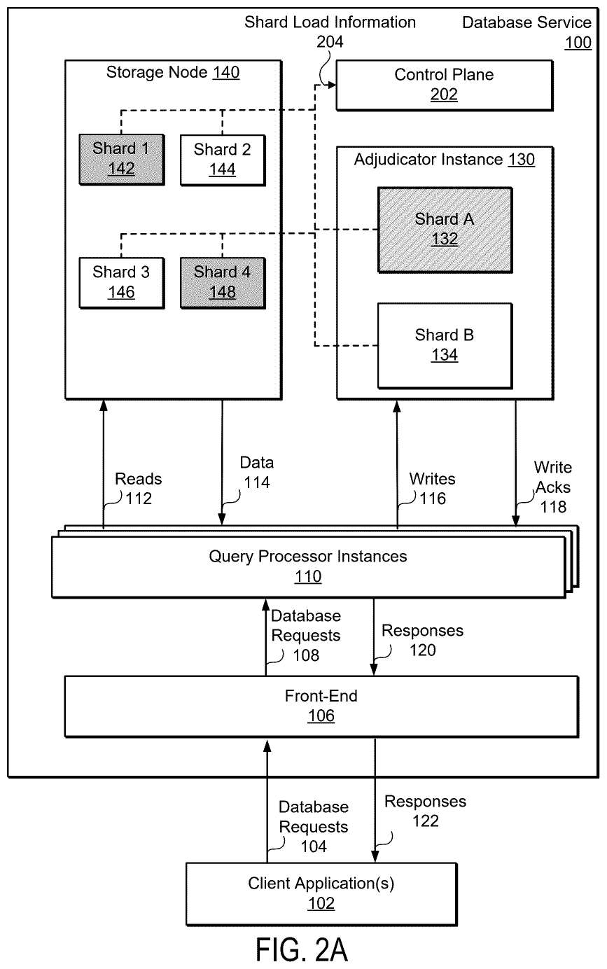

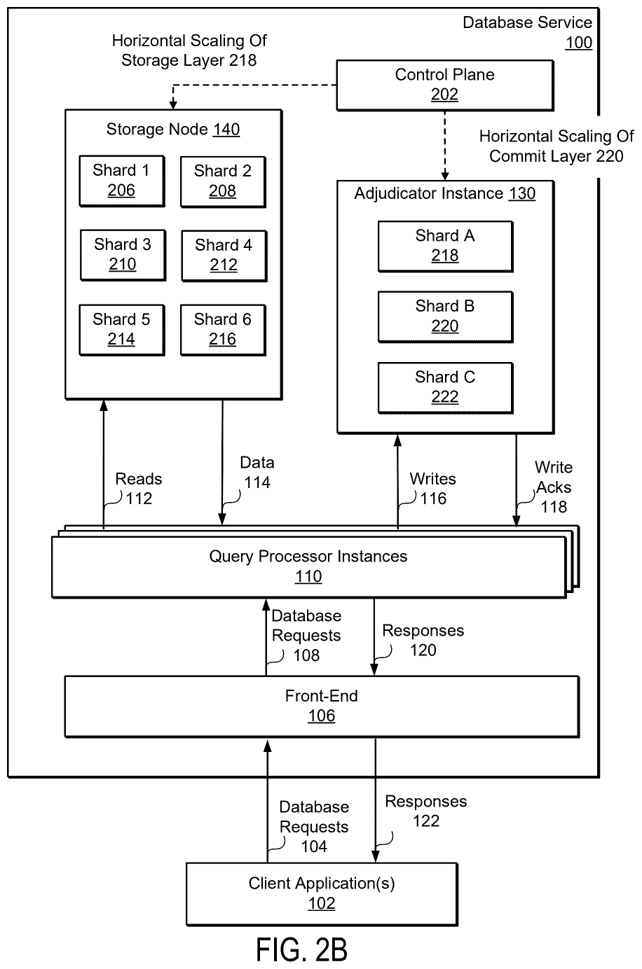

FIGS. 2A-2B are block diagrams illustrating a control plane of a distributed database collecting shard load information and making horizontal scaling decisions based on the collected shard loading information, according to some embodiments.

Note that the example given in FIGS. 1A-1C related to the storage layer and storage nodes of the storage layer which make up a component of the database service 100. But similar vertical scaling techniques may be used for other components of the database service 100, such as for the adjudicator instances of the commit layer, etc.

In some embodiments, a control plane of the database service, such as control plane 202 of database service 100, performs routine health monitoring of the nodes/shards of the respective components of the distributed database service 100. For example, in FIG. 2A, control plane 202 collects shard load information 204 from shards 1, 2, 3, and 4 (142, 144, 146, and 148) of storage node 140 of the storage layer (e.g., a component of the database service 100) and collects shard load information from shards A and B (132 and 134) of adjudicator instance 130 of the commit layer (e.g. another component of the database service 100).

Also, as shown in FIG. 2B, in response to the collected health information (e.g. including shard load information 204) indicating that a threshold for horizontal scaling has been reached, the control plane 202 performs horizontal scaling of the respective components of the database service 100 (e.g. horizontal scaling of the storage layer 218 and horizontal scaling of the commit layer 220). Note that depending on the load information not all components may be horizontally scaled. For example, the storage layer may have a resource usage trend that meets a threshold for horizonal scaling, but the commit layer may have a resource usage trend that does not trigger a horizontal scaling. Also, depending on the respective resource usage trends of each of the components of the distributed database, the respective components may be horizontally scaled in different ways. For example, a number of shards added to the storage layer during a horizontal scaling may differ from a number of shards added to a commit layer during horizontal scaling. For example horizontal scaling 218 of the storage layer results in a re-sharding wherein shards 1-4 (142, 144, 146, and 148) are increased to instead include shards 1-6 (206, 208, 210, 212, 214, and 216). Said another way two shards are added to the storage layer. However horizontal scaling 220 of the commit layer results in only one shard being added to the commit layer, e.g. shards A and B (132 and 134) become shards A, B, and C (218, 220, and 222). Also, horizontal scaling of the various components of the distributed database service 100 may be performed asynchronously.

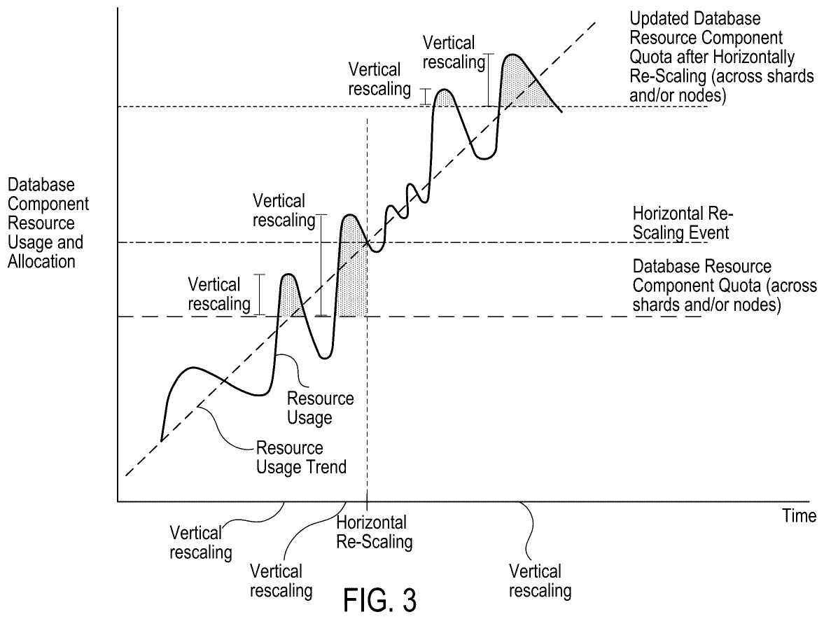

FIG. 3 illustrates an example graph of resource usage over time indicated in collected shard load information, and further illustrates conditions that resulted in vertical scaling and horizontal scaling of components of the distributed database based on the resource usage observed over time, according to some embodiments.

As an example, resource usage may be analyzed by a control plane to determine a resource usage trend that removes at least some of the noise in collected shard load information. Also, as can be seen in FIG. 3 vertical scaling may allow a component of the distributed database to temporarily exceed it source quota until a horizontal re-scaling is performed that increases capacity of the component. As shown in FIG. 3 a horizontal re-scaling is performed which causes the component of the database to be provided an updated database component resource quota.

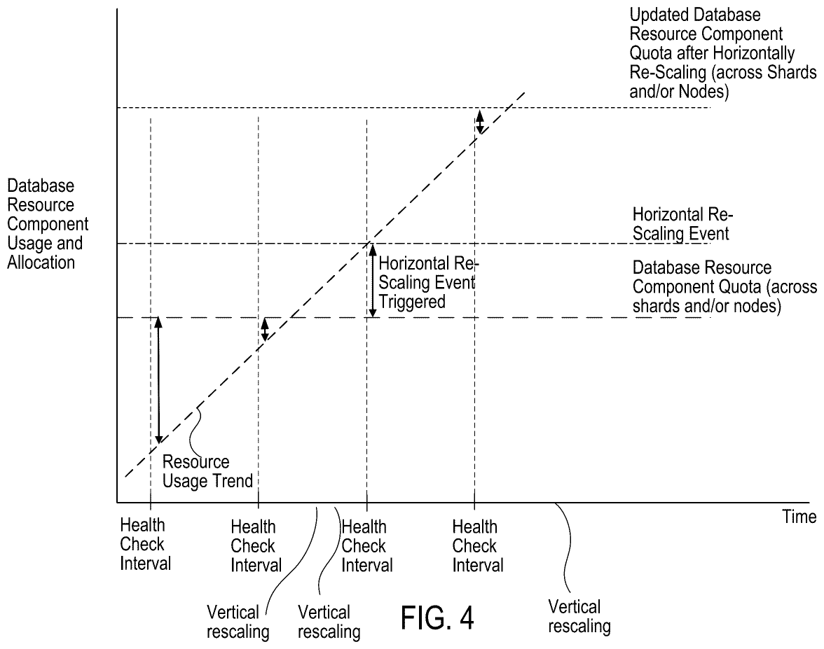

FIG. 4 illustrates an example of a resource usage trend generated by filtering collected load and/or health information, wherein a control plane of the distributed database performs horizontal scaling evaluations using the resource usage trends resulting from the filtering, according to some embodiments.

As can be seen in FIG. 4 the resource usage trend prior to the horizontal re-scaling event showed that the resource usage trend was below the database resource component quota, thus horizontal scaling was not necessarily triggered, even though temporary surges in load caused vertical scaling to be performed prior to the horizontal rescaling, such as the first vertical rescaling shown in FIG. 3.

Also, as can be seen in FIGS. 3 and 4, vertical scaling may be performed at a higher frequency (e.g., may be more responsive) than horizontal scaling which takes places based on load information collected at health check intervals. Additionally, the availability of vertical scaling may be greater than that of horizontal scaling since the vertical scaling is performed locally at a host computing device without a need to contact the control plane.

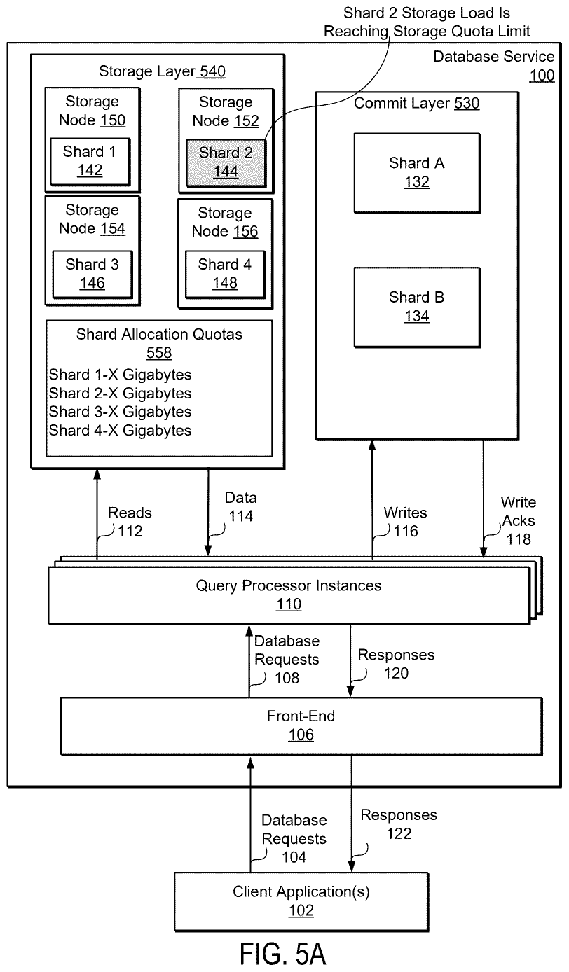

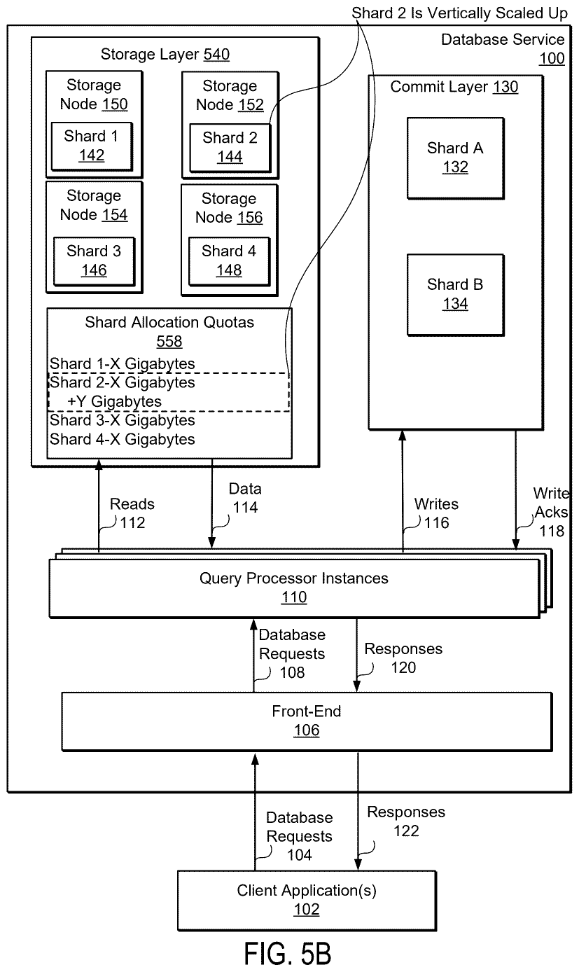

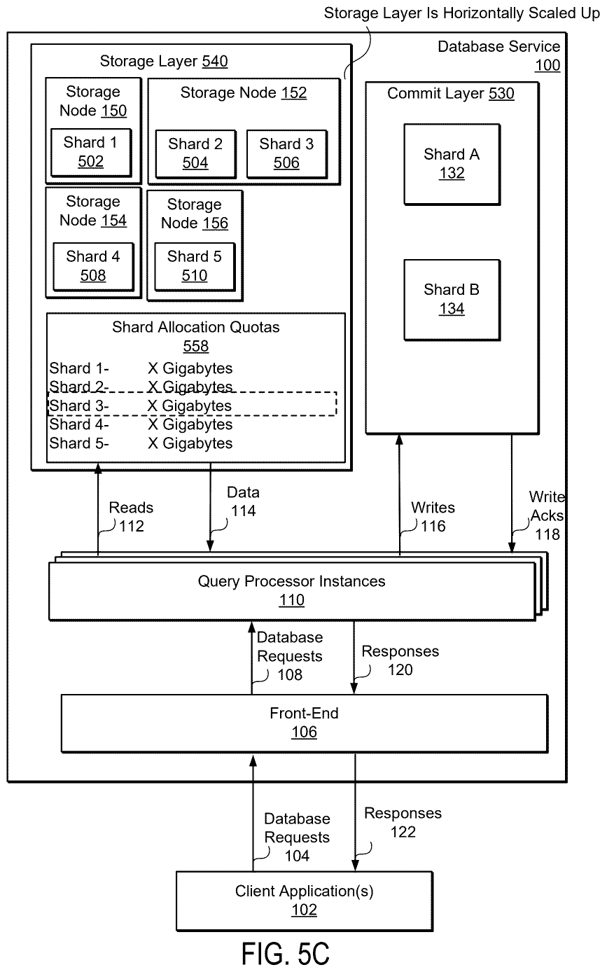

FIGS. 5A-5C are block diagrams illustrating the database service performing a vertical scaling operation with regard to disk storage and also performing a horizontal scaling operation to increase disk storage capacity for a distributed database, according to some embodiments.

In a similar manner as described in FIGS. 1A-1C disk storage space may be vertical scaled. For example, shard allocations 558 allocate different disk storage amounts to shards 1-4 (142, 144, 146, and 148). Also, as shown in FIG. 5A the shard 2 storage load may be reaching its storage quota limit.

As shown in FIG. 5B shard 2 (144) may be vertically scaled such that additional storage space is temporarily allocated to store additional data to shard 2 (144).

Also, at a later moment in time, such as shown in FIG. 5C, the storage layer is horizontally scaled. For example, whereas prior to the scaling storage node 152 hosted shard 2 (144), after the horizontal scaling an additional shard may be implemented such that storage node 152 hosts shards 2 and 3 (504 and 506). Also, storage node 150 host shard 1 (502), storage node 154 host shard 4 (508), and storage node 156 hosts shard 5(510 ).

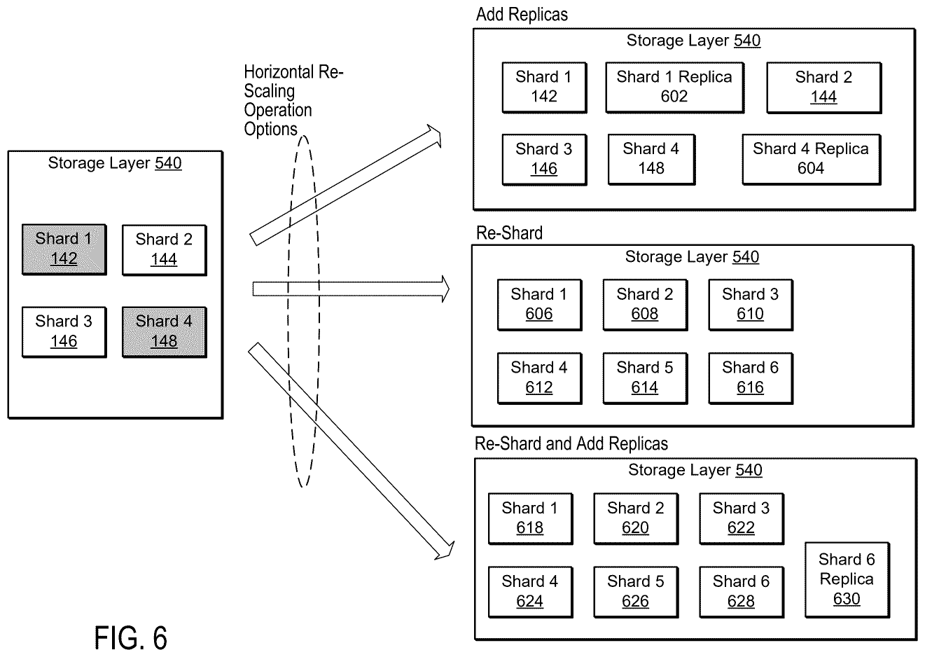

FIG. 6 is a block diagram illustrating example horizontal scaling operations that can be performed to increase a capacity of a set of components of a distributed database, according to some embodiments.

FIG. 6 illustrates example horizontal scaling actions that could be performed for a component of a distributed database, such as storage layer 540. As shown in FIG. 6 shards 1 and 4 (142 and 148) may be indicated to have a high load condition that meets a threshold for horizontal scaling.

As one horizontal scaling option, additional replicas may be added, such as shard 1 replica 602 and shard 4 replica 604.

As another horizontal scaling option, the storage layer 540 may be re-sharded. In a re-sharding assignments of keys to shards may be updated for some, or all, of the shards of the given component being re-sharded. For example, shards 1-4 (142, 144, 146, and 148) may be re-sharded into shards 1-6 (606, 608, 610, 612, 614, and 616).

As yet another horizontal scaling option, the storage layer 540 may be re-sharded and have replicas added. For example, shards 1-4 (142, 144, 146, and 148) may be re-sharded into shards 1-6 (618, 620, 622, 624, 626, and 628). Also a replica 630 of shard 6 may be added during the horizontal scaling.

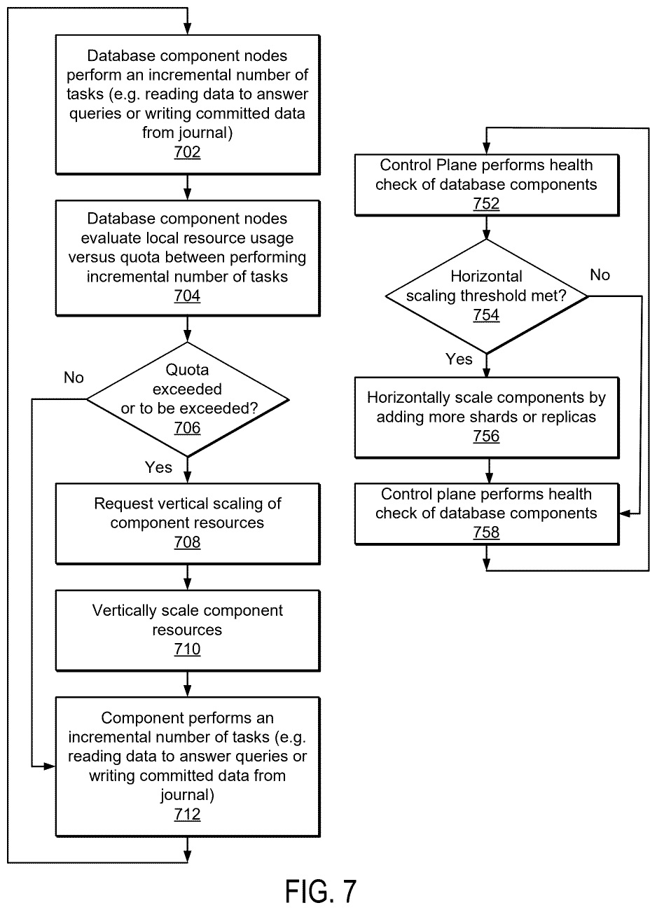

FIG. 7 is a flowchart illustrating processes followed by components of a distributed database to perform vertical and horizontal scaling, according to some embodiments.

At block 702, one or more nodes of a component of the distributed database perform an incremental number of tasks (e.g. reading data to answer queries or writing committed data from journal, as a few examples).

At block 704, the one or more nodes of the component of the distributed database evaluate local resource usage amounts compared to a quota between performing incremental number of tasks. For example, a shard, such as shard 2 (144) as shown in FIG. 1A may evaluate whether its current processor usage, memory usage, or network usage is at, or exceeding, shard allocation quotas, such as shard allocation quotas 158.

At block 706, a local decision is made for a given shard or node with regard to vertical scaling. If that node's (or shard's) quota is exceeded or will imminently be exceeded, then at block 708 the node (or shard) makes a local request for vertical scaling of node (or shard) resources and at block 710 the resources are vertically scaled. If not, then at block 712, the node (or shard) proceeds to perform a next set of incremental tasks.

Also, in a separate sequence, at block 752 a control plane of the distributed database system performs a health check of database components, such as nodes and shards. At block 754, the control plane determines if a resource usage trend, such as shown in FIG. 4, meets a threshold to trigger horizontal scaling. If not, then the control plane continues to perform regular periodic health check at block 758. However, if a threshold for horizontal scaling is met based on longer term resource usage trends, then at block 758 a given component (e.g., storage layer, commit layer, etc.) of the distributed database is horizontally scaled.

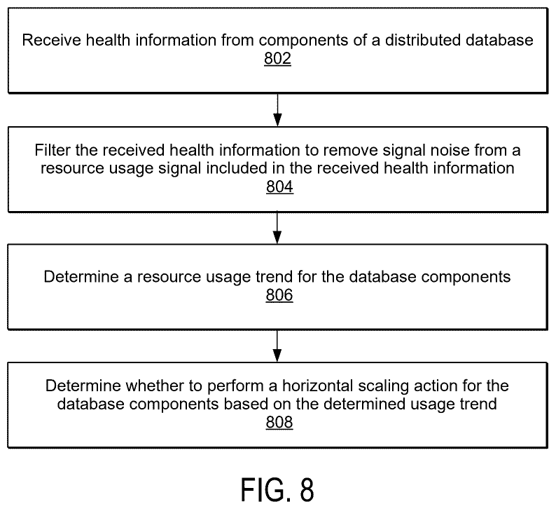

FIG. 8 is a flowchart for a process for a control plane of a distributed database system to collect health information from components of a distributed database system and use the health information to make horizontal scaling decisions for the components, according to some embodiments.

At block 802, a control plane of a distributed database system receives health information from components of a distributed database. For example, the health information may include resource usage information for nodes and shards of the respective components of the distributed database system.

At block 804, the control plane filers the received health information to remove signal noise from a resource usage signal included in the received health information. For example, the resource usage information shown in FIG. 3 may be filtered.

At block 806, the filtered resource usage is used to generate a resource usage trend, such as the resource usage trends shown in FIGS. 3 and 4.

At block 808, the control plane determines whether to perform a horizontal scaling action for the database components based on the determined usage trend. For example, any of the horizontal scaling actions shown in FIG. 6 may be determined to be performed. Also, if a threshold for performing horizontal scaling is not met, then horizontal scaling may not be performed.

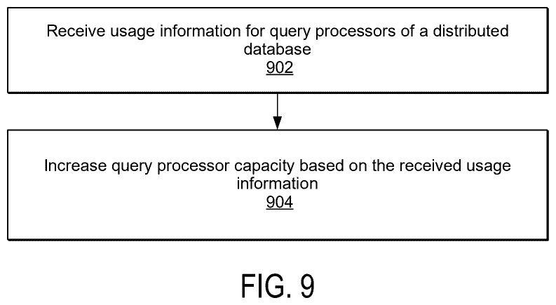

FIG. 9 is a flowchart for a process performed by a control plane to monitor query processor usage and scale query processor capacity, according to some embodiments.

At block 902, a control plane of a distributed database receives usage information for query processors of the distributed database. Based on the query processor usage information, at block 904, the control plane may provide notifications to operators of the distributed database system 100 to increase a number of physical host computing devices used to provide the query processors. This may result in an increase in capacity for providing query processors to customers in response to database connection requests.

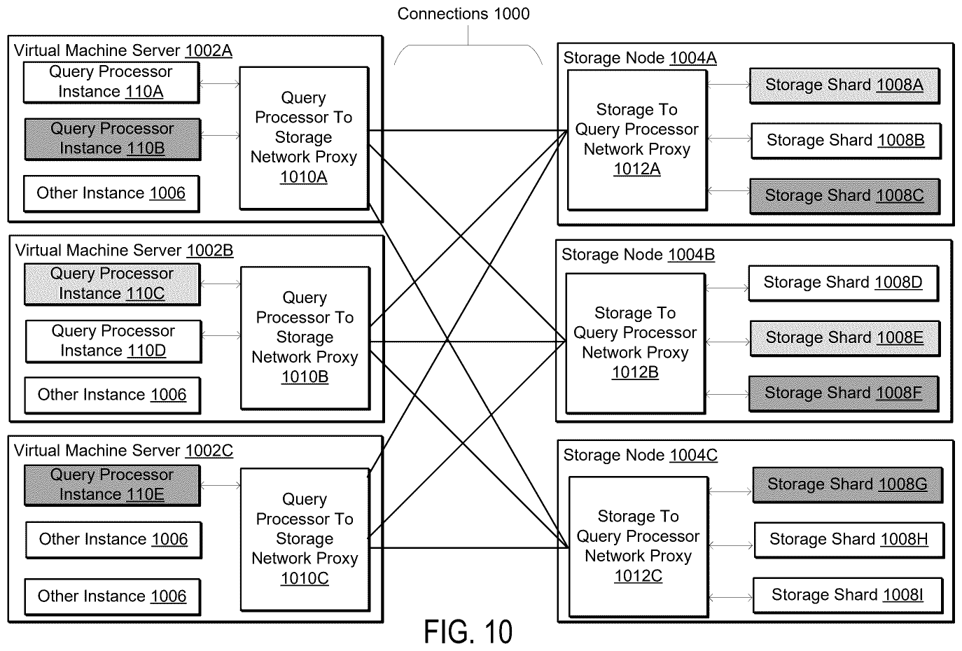

FIG. 10 is a block diagram illustrating a query processor to storage network wherein query processors share connections to storage nodes, according to some embodiments.

Connections 1000, query processor to storage network proxies 1010, and storage to query processor network proxies 1012 may make up a connection layer which enables query processor instances 110 to maintain indirect connections to any storage shards 1008 the query processor instances 110 communicate with, for example, storage shards 1008 of the same cluster as a query processor instance 110. Each illustrated query processor to storage network proxy 1010 is connected, via a connection 1000, to each storage to query processor network proxy 1012. Query processor instances 110 are connected to a query processor to storage network proxy 1010 of the query processor instances' 110 respective virtual machine servers 1002. A virtual machine server 1002 may be a transaction execution host computing device, for example. Storage shards 1008 are connected to the storage to query processor network proxy 1012 of the storage shards' 1008 respective storage nodes 1004. For each of query processor instances 110A-E, there is a connection path to each of storage shards 1008A-I that does not require the query processor 110 to maintain memory space dedicated to each storage shard 1008. Any given query processor instance 110, with correct permissions, is able to connect to any given storage shard 1008 to execute a transaction request. In some embodiments, connections 1000 between network proxies that are not in use may be terminated.

Query processor instances 110 and storage shards 1008 may correspond to particular clusters. As an example, the color of the individual components may indicate color, as an example, query processor instance 110B and query processor instance 110E may correspond to a dark grey cluster with storage shard 1008C, storage shard 1008F, and storage shard 1008G. Individual components of a first cluster may share permissions to interact with data for the first cluster, and individual components of a different cluster may not have permission to interact with data for the first cluster. Network proxies may be generic to clusters, for example, storage to query processor network proxy 1012A may handle and distribute incoming transaction requests for the white, light grey, and dark grey clusters and return data responsive to the transaction requests for all clusters. Data passing through the connection layer of the proxies and connections 1000 may be encrypted, for example by using a token that is shared by other components of the cluster. The query processor instances 110 and storage shards 1008 of a cluster may use a token that is specific to the cluster to encrypt and decrypt data being sent from one component to another.

The proxies may combine data packets which are to be sent along a single connection 1000. For example, query processor to storage network proxy 1010A may combine transaction requests from query processor instance 110A and query processor 110B that are directed to storage shard 1008D and storage shard 1008F respectively into a combined data packet. Storage shard 1008D and storage shard 1008F are both connected to storage to query processor network proxy 1012B. Storage to query processor network proxy 1012B may receive a combined data packet from query processor to storage network proxy 1010A containing the transaction requests from query processor instance 110A and query processor 110B, divide the combined data packet into the transaction requests, and deliver the transaction requests to storage shard 1008D and storage shard 1008F respectively.

The proxies may also combine health information and key range requests. The query processor to storage network proxies 1010 may maintain health information and key range information about each of the storage shards 1008. Instead of sending an individual request directed to each storage shard 1008, query processor to storage network proxy 1010A may send three combined packets requesting health and key range information, one to each of storage to query processor network proxy 1012A, storage to query processor network proxy 1012B, and storage to query processor network proxy 1012C. The storage to query processor network proxies 1012 may divide the combined packets and send them to the connected storage shards 1008. The storage to query processor network proxies 1012 may similarly combine the returning information from the storage shards 1008. In some embodiments, a distribution plane may maintain and provide key range information and the locations of particular storage shards 1008. In some embodiments, a control plane may monitor health information of storage shards 1008 for significant events, such as a crash at a storage node 1004.

The query processor to storage network proxies 1010 may use the health information to know which storage shards 1008 contain the most recently updated data, and may use the key range information to know which storage shards 1008 contain data responsive to particular queries. The query processor to storage network proxies 1010 may determine the target destination of requests from the query processor instances 110 based on the health information and key range information.

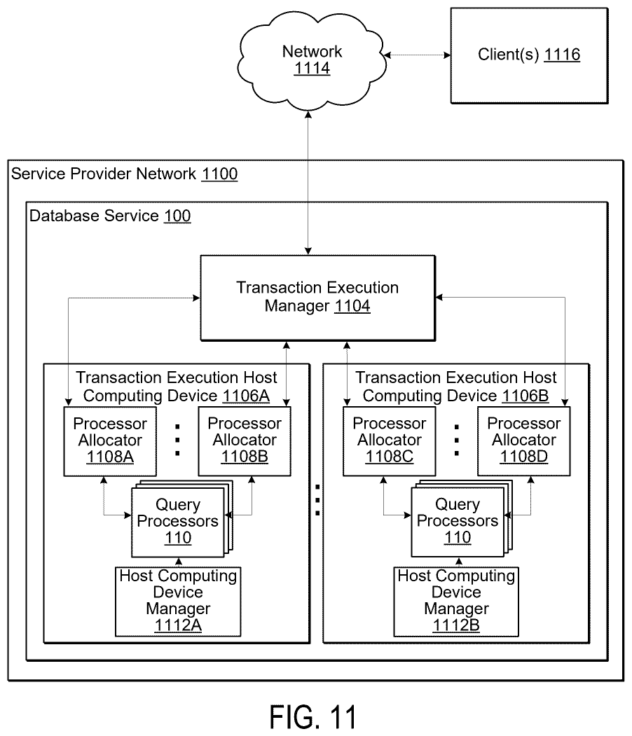

FIG. 11 is a block diagram illustrating a database service which uses a transaction execution manager and processor allocators for distributing client connections and database transactions, according to some embodiments.

For example, the transaction execution managers may assign (e.g. allocate) query processors to clients in response to a connection request to a given distributed database. This allows for quick provisioning of query processors in response to demand and also enables scaling of query processor capacity by allocating more query processors in response to an increase in connection requests.

Clients 1116 may send requests for connections between the clients 1116 and the database service 100 and requests to process transactions to a transaction execution manager 1104. The transaction execution manager 1104 may determine which transaction execution host computing device 1106 to associate client connections with and which transaction execution host computing device 1106 to forward transactions to. Both determinations may be based on consistent hashing or another selection method over a limited set of transaction execution host computing devices 1106 and may also be based on the capacity of the transaction execution host computing devices 1106. The limited set of transaction execution host computing devices 1106 may be based on a number of connections of the cluster and a maximum number of allowed connections per cluster per transaction execution host computing device 1106, i.e., the limited set of transaction execution host computing devices 1106 may have a number of transaction execution host computing devices 1106 equal to the number of connections of the cluster divided by the maximum number of allowed connections per cluster per transaction execution host computing device 1106.

The transaction execution manager 1104 may associate a number of client connections that is or is less than a maximum number of allowed connections per cluster per transaction execution host computing device 1106 with any given transaction execution host computing device 1106. The total number of connections per transaction execution host computing device 1106 may exceed a number of query processors 110 per transaction execution host computing device 1106. For example, transaction execution host computing device 1106A may have two processor allocators 1108, i.e., processor allocator 1108A and processor allocator 1108B, so the transaction execution host computing device 1106A may be associated with two clusters. The transaction execution host computing device 1106A may have ten query processors 110 to allocate between the two associated clusters. The maximum allowed number of connections per cluster per transaction execution host computing device 1106 may be eight. The maximum allowed number of connections per cluster per transaction execution host computing device 1106 may be selected based on a maximum estimated amount of transaction volume, i.e., when the cluster of processor allocator 1108A is operating at capacity, the cluster of processor allocator 1108B is expected to be operating below capacity. In the example, a cluster associated with more than eight connections may be associated with multiple transaction execution host computing devices 1106.

A host computing device manager 1112A may manage virtual machines which are not configured to be query processors and query processors 110 which are not associated with a particular database cluster. For example, the host computing device manager 1112A may instantiate a query processor configuration on a virtual machine not configured to be a query processor to configure the virtual machine to be a query processor 110 that a processor allocator 1108 may select to associate with the cluster of the processor allocator 1108 and process transactions for the cluster. As another example, the host computing device manager 1112A may enable virtual machines nor configured to be query processors to be used for other virtual machine functions.

FIG. 12 is a block diagram illustrating various components of a database service and storage service that host a distributed database, according to some embodiments.

One or more client application(s) 102 may store data to one or more databases maintained by a database service 100. Client application(s) 102 may submit database requests 104 (e.g., requests that cause reads, such as queries or read-only transactions, or requests that cause writes, such as updates, inserts, deletions, or transactions that include write statements) and receive responses 122 from front-end 106.

Front-end 106 may dispatch database requests 108 to a query processor instance 110, which may parse the request and interact with different components according to the type of request. For read requests, query processor instance 110 may rely upon a local cache and/or access storage nodes 1204 by submitting read requests 112 for data, which are returned as data 114 and used to respond to the read. For writes, write requests 116 may be sent to an adjudicator instance 1210, which may determine whether a conflict exists and if not, writes 1208 to journal 1206 and acknowledges the write 118 to query processor instance 110. Responses 120 may then be sent to front-end 106 for response 122 to client application(s) 102. Transactions may be applied to the database by management instance 1204, at a time independent of the write acknowledgement 118, responses 120, and responses 122.

Database service 100 may implement a fleet of host computing devices which may provide, in various embodiments, a multi-tenant configuration so that different query processor instances, such as query processor instance 110 and other query processors, can be hosted on the same virtual machine, but provide access to different databases on behalf of different clients over different connections. In some embodiments, hosts systems may not be multi-tenant and a single virtual machine may implement a single query processor instance 110 which may provide access to a single database for a single client.

In some embodiments, database data for a database of database service 100 may be stored in a separate storage service 1200. In some embodiments, storage service 1200 may be implemented to store database data as virtual disk or other persistent storage drives. In some embodiments, embodiments, storage service 1200 may store data for databases using tree structured storage and log structured storage.

For example, data may be organized in various logical volumes, segments, and pages for storage on one or more storage nodes 1202 of storage service 1200. For example, in some embodiments, each database may be represented by a logical volume, and each logical volume may be segmented into storage shards over a collection of storage nodes 1202. A storage shard may be an individual component that an individual query processor instance 110, for example, may communicate with. Each storage shard, which may be hosted on a particular one of the storage nodes, may contain a set of contiguous block addresses, in some embodiments.

In at least some embodiments, storage nodes 1202 may provide multi-tenant storage so that data stored in a storage shard of one storage device may be stored for a different database, database user, account, or entity than data stored in another storage shard on the same storage device (or other storage devices) of the same storage node 1202. Various access controls and security mechanisms may be implemented, in some embodiments, to ensure that data is not accessed at a storage node 1202 except for authorized requests (e.g., for users authorized to access the database, owners of the database, etc.). For example, a cluster of database components may correspond to a particular database, and may use tokens specific to the cluster to identify and encrypt data.

In some embodiments, each storage shard may store a collection of one or more data pages and a change log (also referred to as a redo log) (e.g., a log of redo log records) for each data page that it stores. Storage nodes 1202 may receive redo log records and coalesce them to create new versions of the corresponding data and/or additional or replacement log records (e.g., lazily and/or in response to a request for data or a database crash). In some embodiments, data and/or change logs may be mirrored across multiple storage nodes 1202, according to a variable configuration (which may be specified by the client on whose behalf the database is being maintained in the database system). For example, in different embodiments, one, two, or three copies of the data or change logs may be stored in each of one, two, or three different availability zones or regions, according to a default configuration, an application-specific durability preference, or a client-specified durability preference.

In some embodiments, a volume may be a logical concept representing a highly durable unit of storage that a user/client/application of the storage system understands. A volume may be a distributed store that appears to the user/client/application as a single consistent ordered log of write operations to various user pages of a database, in some embodiments. Each write operation may be encoded in a log record (e.g., a redo log record), which may represent a logical, ordered mutation to the contents of a single user page within the volume, in some embodiments. Each log record may include a unique identifier (e.g., a Logical Sequence Number (LSN)), in some embodiments. Each log record may be persisted to one or more synchronous segments in the distributed store that form a Protection Group (PG), to provide high durability and availability for the log record, in some embodiments. A volume may provide an LSN-type read/write interface for a variable-size contiguous range of bytes, in some embodiments.

In some embodiments, journal 1206, which may be a logical journal, may be hosted in database service 100 that stores ordered updates to the database (e.g., to a database volume). Adjudicator instances 1210 may be responsible for deciding whether transactions or writes can be committed (while following isolation rules), for working with database journal 1206 to order transactions, and for ensuring that committed data is consistent. Management instances 1204, which may be a logical crossbar server, may apply updates to the database stored at the storage nodes 1202 from the database journal 1206 as directed by the adjudicator instances 1210.

Front-end 106 may implement a proxy, request router, or other load balancing feature that routes database requests to one or more query processor instances 110. For example, front-end 106 may be responsible for authenticating requests to connect to a database at a particular network endpoint and allocating a query processor instance 110 to the connection (or to a particular request such as a read or a write). The front-end 106 may maintain the connection (e.g., as a proxy) so that if different query processor instances 110 are used for different requests to the database, separate connections do not have to be established.

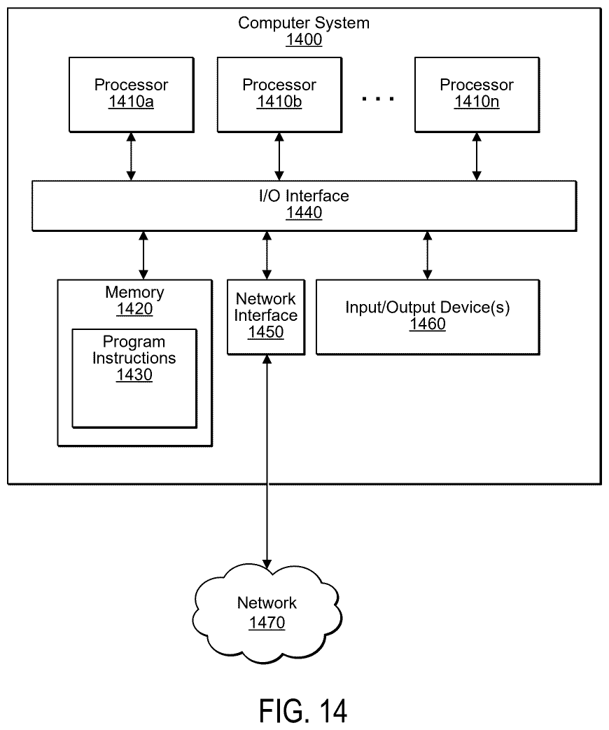

Database service 100 may implement a control plane which may manage the creation, provisioning, deletion, or other features of managing a database hosted in database service 100. For example, the control plane may monitor the performance of host computing devices (e.g., a computing system or device like computing system 1400 discussed below with regard to FIG. 14) for high workloads (e.g., heat) and move or redirect placement of database engine head node instances away from some host computing devices to avoid overburdening host computing devices. The control plane may handle various management requests, such as requests to create databases or manage databases (e.g., by configuring or modifying performance), such as by enabling a “serverless” or other automated management feature in response to a request which may cause in-place resource scaling to be enabled for that database. The control plane may direct placement of database engine head node instances on host computing devices so as to distribute workload across host computing devices to avoid failure scenarios, like out-of-memory.

Database service 100 may implement one or more different types of database systems with respective query processor instances 110 for accessing database data as part of the database. For example, database service 100 may implement various types of connection-based (e.g., having established a network connection between a database client and query processor instances 110 on a database host system) database systems which may, for instance, facilitate the performance of various operations that continue over multiple communications between the database client and the connected query processor instance 110. In at least some embodiments, database service 100 may be a relational database service that hosts relational databases on behalf of clients.

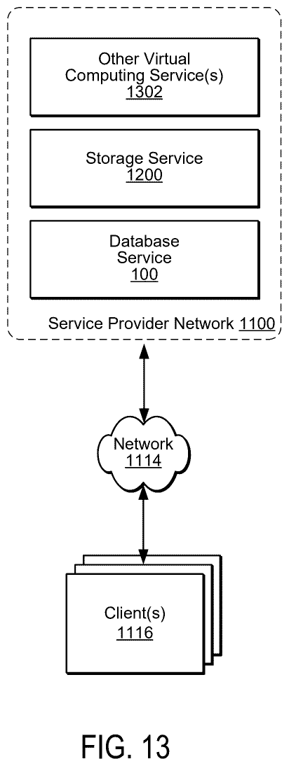

FIG. 13 is a block diagram illustrating a provider network that may implement database services that implement techniques described herein, according to some embodiments.

A service provider network 1100 (sometimes referred to as a “cloud provider network” or “cloud”) refers to a pool of network-accessible computing resources (such as compute, storage, and networking resources, applications, and services), which may be virtualized or bare-metal. The service provider network 1100 can provide convenient, on-demand network access to a shared pool of configurable computing resources that can be programmatically provisioned and released in response to user commands. These resources can be dynamically provisioned and reconfigured to adjust to variable load. Cloud computing can thus be considered as both the applications delivered as services over a publicly accessible network 114 (e.g., the Internet, a cellular communication network) and the hardware and software in cloud provider data centers that provide those services.

A service provider network 1100 can be formed as a number of regions, where a region is a separate geographical area in which the cloud provider clusters data centers. Each region can include two or more availability zones connected to one another via a private high-speed network, for example, a fiber communication connection. An availability zone (also known as an availability domain, or simply a “zone”) refers to an isolated failure domain including one or more data center facilities with separate power, separate networking, and separate cooling from those in another availability zone. A data center refers to a physical building or enclosure that houses and provides power and cooling to servers of the cloud provider network. Preferably, availability zones within a region are positioned far enough away from one other that the same natural disaster should not take more than one availability zone offline at the same time. Users can connect to availability zones of the provider network via a publicly accessible network (e.g., the Internet, a cellular communication network) by way of a transit center (TC). TCs can be considered as the primary backbone locations linking users to the provider network, and may be collocated at other network provider facilities (e.g., Internet service providers, telecommunications providers) and securely connected (e.g. via a VPN or direct connection) to the availability zones. Each region can operate two or more TCs for redundancy. Regions are connected to a global network connecting each region to at least one other region. The provider network may deliver content from points of presence outside of, but networked with, these regions by way of edge locations and regional edge cache servers (points of presence, or PoPs). This compartmentalization and geographic distribution of computing hardware enables the provider network to provide low-latency resource access to users on a global scale with a high degree of fault tolerance and stability.

The provider network may implement various computing resources or services, which may include a virtual compute service, data processing service(s) (e.g., map reduce, data flow, and/or other large scale data processing techniques), data storage services (e.g., object storage services, block-based storage services, or data warehouse storage services) and/or any other type of network based services (which may include various other types of storage, processing, analysis, communication, event handling, visualization, and security services not illustrated). The resources required to support the operations of such services (e.g., compute and storage resources) may be provisioned in an account associated with the cloud provider, in contrast to resources requested by users of the provider network, which may be provisioned in user accounts.

The traffic and operations of the provider network may broadly be subdivided into two categories in various embodiments: control plane operations carried over a logical control plane and data plane operations carried over a logical data plane. While the data plane represents the movement of user data through the distributed computing system, the control plane represents the movement of control signals through the distributed computing system. The control plane generally includes one or more control plane components distributed across and implemented by one or more control servers. Control plane traffic generally includes administrative operations, such as system configuration and management (e.g., resource placement, hardware capacity management, diagnostic monitoring, system state information). The data plane includes customer resources that are implemented on the cloud provider network (e.g., computing instances, containers, block storage volumes, databases, file storage). Data plane traffic generally includes non-administrative operations such as transferring customer data to and from the customer resources. Certain control plane components (e.g., tier one control plane components such as the control plane for a virtualized computing service) are typically implemented on a separate set of servers from the data plane servers, while other control plane components (e.g., tier two control plane components such as analytics services) may share the virtualized servers with the data plane, and control plane traffic and data plane traffic may be sent over separate/distinct networks.

An exemplary provider network may include numerous provider network regions and so on that may include one or more data centers hosting various resource pools, such as collections of physical and/or virtualized computer servers, storage devices, networking equipment and the like (e.g., computing system 1400 described below with regard to FIG. 14), needed to implement and distribute the infrastructure and storage services offered by the provider network within the provider network regions.

As illustrated in FIG. 13, a number of clients (shown as clients 116) may interact with a service provider network 1100 via a network 1114. Service provider network 1100 may implement respective instantiations of the same (or different) services, such as a database service 100 for a first region and a second instantiation of database service 100 for a second region, and so on. Similar arrangements may be implemented for storage service 1200, as well as various other virtual computing services 1302. It is noted that where one or more instances of a given component may exist, reference to that component herein may be made in either the singular or the plural. However, usage of either form is not intended to preclude the other.

In various embodiments, the components illustrated in FIG. 13 may be implemented directly within computer hardware, as instructions directly or indirectly executable by computer hardware (e.g., a microprocessor or computer system), or using a combination of these techniques. For example, the components of FIG. 13 may be implemented by a system that includes a number of computing nodes (or simply, nodes), each of which may be similar to the computer system embodiment illustrated in FIG. 14 and described below. In various embodiments, the functionality of a given service system component (e.g., a component of the database service or a component of the storage service) may be implemented by a particular node or may be distributed across several nodes. In some embodiments, a given node may implement the functionality of more than one service system component (e.g., more than one database service system component).

Generally speaking, clients 116 may encompass any type of client configurable to submit network-based services requests to service provider network 1100 via network 1114, including requests for database services. For example, a given client 116 may include a suitable version of a web browser, or may include a plug-in module or other type of code module that may execute as an extension to or within an execution environment provided by a web browser. Alternatively, a client 1116 (e.g., a database service client) may encompass an application such as a database application (or user interface thereof), a media application, an office application or any other application that may make use of persistent storage resources to store and/or access one or more database tables. In some embodiments, such an application may include sufficient protocol support (e.g., for a suitable version of Hypertext Transfer Protocol (HTTP)) for generating and processing network-based services requests without necessarily implementing full browser support for all types of network-based data. That is, client 1116 may be an application which may interact directly with service of a region of a provider network. In some embodiments, client 1116 may generate network-based services requests according to a Representational State Transfer (REST)-style web services architecture, a document-based or message-based network-based services architecture, or another suitable network-based services architecture. Although not illustrated, some clients of service provider network 1100 services may be implemented within a service of the provider network (e.g., a client application of database service 100 may be implemented on one of other virtual computing service(s) 1302), in some embodiments. Therefore, various examples of the interactions discussed with regard to clients 1116 may be implemented for internal clients as well, in some embodiments.

In some embodiments, a client 1116 (e.g., a database service client) may be provided access to network-based storage of database data to other applications in a manner that is transparent to those applications. For example, client 1116 may be integrated with an operating system or file system to provide storage in accordance with a suitable variant of the storage models described herein. However, the operating system or file system may present a different storage interface to applications, such as a conventional file system hierarchy of files, directories, and/or folders. In such an embodiment, applications may not need to be modified to make use of the storage system service model, as described above. Instead, the details of interfacing to the provider network may be coordinated by client 1116 and the operating system or file system on behalf of applications executing within the operating system environment.

Clients 1116 may convey network-based services requests to and receive responses from a region of the provider network via network 1114. In various embodiments, network 1114 may encompass any suitable combination of networking hardware and protocols necessary to establish network-based communications between clients 1116 and a service provider network 1100. For example, network 1114 may generally encompass the various telecommunications networks and service providers that collectively implement the Internet. Network 1114 may also include private networks such as local area networks (LANs) or wide area networks (WANs) as well as public or private wireless networks. For example, both a given client 1116 and the provider network region may be respectively provisioned within enterprises having their own internal networks. In such an embodiment, network 1114 may include the hardware (e.g., modems, routers, switches, load balancers, proxy servers, etc.) and software (e.g., protocol stacks, accounting software, firewall/security software, etc.) necessary to establish a networking link between given client 1116 and the Internet as well as between the Internet and a provider network. It is noted that in some embodiments, clients 1116 may communicate with regions of a provider network using a private network rather than the public Internet. For example, clients 1116 may be provisioned within the same enterprise as a database service. In such a case, clients 1116 may communicate with a provider network region entirely through a private network 1114 (e.g., a LAN or WAN that may use Internet-based communication protocols but which is not publicly accessible).

Generally speaking, service provider network 1100 may implement one or more service endpoints which may receive and process network-based services requests, such as requests to access a database (e.g., queries, inserts, updates, etc.) and/or manage a database (e.g., create a database, configure a database, etc.). For example, a provider network region may include hardware and/or software which may implement a particular endpoint, such that an HTTP-based network-based services request directed to that endpoint is properly received and processed. In one embodiment, a provider network region may be implemented as a server system may receive network-based services requests from clients 1116 and to forward them to components of a system that implements database service 100, storage service 1200, and/or another virtual computing service 1302 for processing. In other embodiments, provider network region may be configured as a number of distinct systems (e.g., in a cluster topology) implementing load balancing and other request management features may dynamically manage large-scale network-based services request processing loads. In various embodiments, a provider network region may support REST-style or document-based (e.g., SOAP-based) types of network-based services requests.

In addition to functioning as an addressable endpoint for clients' network-based services requests, in some embodiments, a service provider network 1100 may implement various client management features. For example, service provider network 1100 may coordinate the metering and accounting of client usage of network-based services, including storage resources, such as by tracking the identities of requesting clients 1116, the number and/or frequency of client requests, the size of data tables (or records thereof) stored or retrieved on behalf of clients 1116, overall storage bandwidth used by clients 1116, class of storage requested by clients 1116, or any other measurable client usage parameter. Provider network regions may also implement financial accounting and billing systems, or may maintain a database of usage data that may be queried and processed by external systems for reporting and billing of client usage activity. In certain embodiments, provider network regions may collect, monitor and/or aggregate a variety of storage service system operational metrics, such as metrics reflecting the rates and types of requests received from clients 1116, bandwidth utilized by such requests, system processing latency for such requests, system component utilization, such as the target capacity determined for individual database engine head node instances, network bandwidth and/or storage utilization, rates and types of errors resulting from requests, characteristics of storage and databases (e.g., size, data type, etc.), or any other suitable metrics. In some embodiments, such metrics may be used by system administrators to tune and maintain system components, while in other embodiments such metrics (or relevant portions of such metrics) may be exposed to clients 1116 to enable such clients to monitor their usage of database service 100, storage service 1200 and/or another virtual computing service 1302 (or the underlying systems that implement those services).

In some embodiments, provider network regions may also implement user authentication and access control procedures. For example, for a given network-based services request to access a particular database table, a provider network region may ascertain whether the client 1116 associated with the request is authorized to access the particular database table. Provider network regions may determine such authorization by, for example, evaluating an identity, password or other credential against credentials associated with the particular database table, or evaluating the requested access to the particular database table against an access control list for the particular database table. For example, if a client 1116 does not have sufficient credentials to access the particular database table, the provider network region may reject the corresponding network-based services request, for example by returning a response to the requesting client 1116 indicating an error condition. Various access control policies may be stored as records or lists of access control information by database services 102, storage services 1200, and/or other virtual computing services 1302.

Note that in many of the examples described herein, services, like database service 100 or storage service 1200 may be internal to a computing system or an enterprise system that provides database services to clients 1116, and may not be exposed to external clients (e.g., users or client applications). In such embodiments, the internal “client” (e.g., database service 100) may access storage service 1200 over a local or private network (e.g., through an API directly between the systems that implement these services). In such embodiments, the use of storage service 1200 in storing database storage structures on behalf of clients 1116 may be transparent to those clients. In other embodiments, storage service 1200 may be exposed to clients 1116 through service provider network 1100 to provide storage of database tables or other information for applications other than those that rely on database service 100 for database management. In such embodiments, clients of the storage service 1200 may access storage service 1200 via network 1114 (e.g., over the Internet). In some embodiments, a virtual computing service 1302 may receive or use data from storage service 1200 (e.g., through an API directly between the virtual computing service 1302 and storage service 1200) to store objects used in performing computing services 1302 on behalf of a client 1116. In some cases, the accounting and/or credentialing services of provider network region may be unnecessary for internal clients such as administrative clients or between service components within the same enterprise.

### Example Computer System

FIG. 14 is a block diagram illustrating an example computer system that implements some or all of the techniques described herein, according to some embodiments.

FIG. 14 illustrates exemplary computer system 1400 usable to implement the processor allocator as described above with reference to FIGS. 1-13. In different embodiments, computer system 1400 may be any of various types of devices, including, but not limited to, a network computer, a mobile device, a consumer device, application server, storage device, a peripheral device such as a switch, modem, router, or in general any type of computing or electronic device.

Various embodiments of program instructions for a processor allocator 1430, as described herein, may be executed in one or more computer systems 1400, which may interact with various other devices. Note that any component, action, or functionality described above with respect to FIGS. 1-13 may be implemented on one or more computers configured as computer system 1400 of FIG. 14, according to various embodiments. In the illustrated embodiment, computer system 1400 includes one or more processors 1410 coupled to a system memory 1420 via an input/output (I/O) interface 1440. Computer system 1400 further includes a network interface 1450 coupled to I/O interface 1440, and one or more input/output devices 1460. In some cases, it is contemplated that embodiments may be implemented using a single instance of computer system 1400, while in other embodiments multiple such computer systems, or multiple nodes making up computer system 1400, may be configured to host different portions or instances program instructions as described above for various embodiments. For example, in one embodiment some elements of the program instructions may be implemented via one or more nodes of computer system 1400 that are distinct from those nodes implementing other elements.

In some embodiments, computer system 1400 may be implemented as a system on a chip (SoC). For example, in some embodiments, processors 1410, memory 1420, I/O interface 1440 (e.g., a fabric), etc. may be implemented in a single SoC comprising multiple components integrated into a single chip. For example, a SoC may include multiple CPU cores, a multi-core GPU, a multi-core neural engine, cache, one or more memories, etc. integrated into a single chip. In some embodiments, an SoC embodiment may implement a reduced instruction set computing (RISC) architecture, or any other suitable architecture.

System memory 1420 may be configured to store compression or decompression program instructions for a processor allocator 1430 accessible by one or more of the processors 1410. In various embodiments, system memory 1420 may be implemented using any suitable memory technology, such as static random-access memory (SRAM), synchronous dynamic RAM (SDRAM), nonvolatile/Flash-type memory, or any other type of memory. In the illustrated embodiment, program instructions for a processor allocator 1430 may be configured to implement any of the functionality described above. In some embodiments, program instructions and/or data may be received, sent, or stored upon different types of computer-accessible media or on similar media separate from system memory 1420 or computer system 1400.

In one embodiment, I/O interface 1440 may be configured to coordinate I/O traffic between processor 1410, system memory 1420, and any peripheral devices in the device, including network interface 1450 or other peripheral interfaces, such as input/output devices 1460. In some embodiments, I/O interface 1440 may perform any necessary protocol, timing, or other data transformations to convert data signals from one component (e.g., system memory 1420) into a format suitable for use by another component (e.g., processor 1410). In some embodiments, I/O interface 1440 may include support for devices attached through various types of peripheral buses, such as a variant of the Peripheral Component Interconnect (PCI) bus standard or the Universal Serial Bus (USB) standard, for example. In some embodiments, the function of I/O interface 1440 may be split into two or more separate components, such as a north bridge and a south bridge, for example. Also, in some embodiments, some or all of the functionality of I/O interface 1440, such as an interface to system memory 1420, may be incorporated directly into processor 1410.

Network interface 1450 may be configured to allow data to be exchanged between computer system 1400 and other devices attached to a network 1470 (e.g., carrier or agent devices) or between nodes of computer system 1400. Network 1470 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1450 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1460 may, in some embodiments, include one or more display terminals, keyboards, keypads, touchpads, scanning devices, voice or optical recognition devices, or any other devices suitable for entering or accessing data by one or more computer systems 1400. Multiple input/output devices 1460 may be present in computer system 1400 or may be distributed on various nodes of computer system 1400. In some embodiments, similar input/output devices may be separate from computer system 1400 and may interact with one or more nodes of computer system 1400 through a wired or wireless connection, such as over network interface 1450.

As shown in FIG. 14, memory 1420 may include program instructions for a processor allocator 1430, which may be processor-executable to implement any element or action described above. In one embodiment, the program instructions may implement the methods described above. In other embodiments, different elements and data may be included.

Computer system 1400 may also be connected to other devices that are not illustrated, or instead may operate as a stand-alone system. In addition, the functionality provided by the illustrated components may in some embodiments, be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1400 may be transmitted to computer system 1400 via transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A system comprising:
a first set of computing devices configured to implement query processor instances for a distributed database;
a second set of computing devices configured to implement adjudicator instances for the distributed database, wherein the adjudicator instances are configured to commit writes included in transactions processed by the query processor instances;
a third set of computing devices configured to implement storage nodes for the distributed database, wherein the storage nodes are configured to read data requested in transactions processed by the query processor instances,
wherein the first, second, and third sets of computing devise are configured to:
vertically scale a resource allocation of a given adjudicator instance, storage node, or query processor, to increase a capacity of the given adjudicator instance, storage node, or query processor to perform database operations; and
one or more computing devices configured to implement a control plane for the distributed database, wherein the control plane is configured to:
horizontally scale the adjudicator instances, the storage nodes, or the query processors such that a greater number of adjudicator instances, storage nodes, or query processors are used to perform the database operations, wherein the greater number of adjudicator instances, storage nodes, or query processors increases a capacity of the adjudicator instances, the storage nodes, or the query processors to perform the database operations.

2. The system of claim 1, wherein to vertically scale the resource allocation of the given adjudicator instance, storage node, or query processor, the first, second, or third sets of computing devices are configured to:
increase a processor resource allocation;
increase a memory resource allocation; or
increase a network resource allocation,
of the given adjudicator instance, storage node, or query processor.

3. The system of claim 2, wherein to vertically scale the resource allocation of the given storage node, the control plane is further configured to:
increase a total storage amount allocated to a given shard stored by the given storage node.

4. The system of claim 1 wherein to horizontally scale the adjudicator instances or the storage node, the control plane is configured to:
re-shard database data stored in a commit layer or a storage layer, wherein the re-sharding results in a larger number of adjudicator instances or storage nodes being used to store the database data, and wherein the re-sharding results in respective ones of the shards comprising data for fewer keys of the database data.

5. The system of claim 1 wherein to horizontally scale the storage nodes, the control plane is configured to:
add one or more replica storage nodes for a given one of the storage nodes, wherein the one or more replica storage nodes store data for a same set of keys as the given storage node they replicate.

6. A method, comprising:
vertically scaling, by a control plane of a distributed database, in response to a first increase in transaction load, a resource allocation of a given node of the distributed database to increase a capacity of the given node; and
horizontally scaling, by the control plane, in response to a second increase in transaction load, a component of the distributed database that includes the given node such that a greater number of nodes are used for the distributed database, wherein the greater number of nodes increases a capacity of the component of the distributed database.

7. The method of claim 6, wherein:
said vertically scaling the resource allocation of a given node of one of the components of the distributed database is performed within a first amount of time relative to the first increase in the transactional load,
said horizontally scaling the component of the distributed database is performed within a second amount of time relative to the second increase in transaction load, and
the first amount of time is a shorter amount of time than the second amount of time.

8. The method of claim 6, further comprising:
receiving, at a host computing device hosting the given node, a request from the given node to increase the capacity of the given node; and
determining, by the host computing device hosting the given node, that a current resource usage of one or more other ones of the nodes hosted by the host computing device hosting the given storage node are less than a threshold,
wherein said vertically scaling the resource allocation of the given node is performed based on the one or more other ones of the nodes having less than the threshold current resource usage.

9. The method of claim 6, wherein:
the vertical scaling is performed locally at a host computing device hosting the given node in response to the request from the given node; and
the horizontal scaling is performed by a control plane of the distributed database in response to health information collected from the nodes of the components of the distributed database by the control plane.

10. The method of claim 9, wherein the host computing device is configured to perform said vertical scaling in response to requests from the nodes of the components of the distributed database at a higher frequency than a frequency at which the health information is collected from the nodes of the components of the distributed database.

11. The method of claim 9, further comprising:
determining, by the control plane, a resource usage trend for the respective ones of the nodes of the components of the distributed database based on the collected health information.

12. The method of claim 11, further comprising:
filtering, by the control plane, the collected health information to remove signal noise from a resource usage signal used to determine the resource usage trend.

13. The method of claim 12, wherein:
said horizontally scaling is performed based on the resource usage trend generated using filtered collected health information; and
said vertically scaling is performed based on current resource usage by a given storage node.

14. The method of claim 6, further comprising:
scaling a number of query processor instances configured to process queries comprising transactions that include reads to be directed to the storage layer or writes to be directed to a commit layer of the distributed database.

15. The method of claim 14, further comprising:
implementing respective network proxies at respective ones of a first set of computing devices implementing the query processors;
implementing additional respective network proxies at respective ones of a second set of computing devices implementing the storage nodes;
establishing one or more network connections between one or more of the respective ones of the network proxies and respective ones of the additional network proxies; and
sharing, by the query processors and the storage nodes, the one or more network connections established between the network proxies and the additional network proxies.

16. The method of claim 14, wherein said scaling the number of query processor instances further comprises:
maintaining a warm pool of query processors, wherein the warm pool comprises instantiated virtual computing instances configured to implement query processors for a given client of the distributed database upon receiving client specific configuration information; and
maintaining an active pool of query processors comprising client specific configuration information.

17. One or more non-transitory, computer-readable storage media storing program instructions that, when executed using one or more processors, cause the one or more processors to:
vertically scale in response to a first increase in transaction load, a resource allocation of a given node of a distributed database to increase a capacity of the given node; and
horizontally scale, by a control plane of the distributed database, in response to a second increase in transaction load, a component of the distributed database that includes the given node such that a greater number of nodes are used for the distributed database, wherein the greater number of nodes increases a capacity of the component of the distributed database.

18. The one or more non-transitory, computer-readable storage media of claim 17, wherein:
the horizontally scaling is performed based on a resource usage trend generated using collected health information; and
the vertically scaling is performed based on a current resource usage by a given storage node.

19. The one or more non-transitory, computer-readable storage media of claim 18, wherein the program instructions, when executed using the one or more processors, further cause the one or more processors to:
collect the health information from the nodes of the components of the distributed database; and
filter the collected health information to remove noise.

20. The one or more non-transitory, computer-readable storage media of claim 18, wherein the program instructions, when executed using the one or more processors, further cause the one or more processors to:
receive, at a local host, a request from the given node to increase the capacity of the given storage node to read data requested in transactions; and
perform, at the local host, the vertical scaling of the given storage node without waiting for a horizontal scaling evaluation interval.
